(19) United States
(12) Patent Application Publication
(10) Pub. No.: US 2006/0059538 A1
(43) Pub. Date: Mar. 16, 2006

(54) Security system for wireless networks

(75) Inventor: Sung Joon Lee, Fort Lee, NJ (US)

Correspondence Address: COHEN, PONTANI, LIEBERMAN & PAVANE, 551 FIFTH AVENUE, SUITE 1210, NEW YORK, NY, 10176, US

(73) Assignee: Xcomm Box, Inc.

(21) Appl. No.: 10/939,663

(22) Filed: Sep. 13, 2004

(51) Int. Cl. H04L 9/00

(52) U.S. Cl. 726/1

(57) ABSTRACT

A security procedure for invoking IPsec security for communication of a packet in a network includes the steps of generating a message to be sent at the transport layer, building Internet Protocol and Transport Control Protocol headers for the message, selecting a security policy in accordance with a security policy database after the step of building Internet Protocol and Transport Control Protocol headers, and processing the packet according to the selected security policy.

### BACKGROUND OF THE INVENTION

1. Field of the Invention

The present invention relates to a security procedure for communication within a Wireless Local Area Network (WLAN). The present invention also relates to a WLAN implementing the security procedure.

2. Description of the Related Art

Wireless Local Area Networks (WLANs) allow communication between computing devices without cables. WLANs may operate in an ad-hoc mode, in which each computer, or client, communicates directly with the other clients in the network, or an infrastructure mode, in which each client sends all communications through an access point which acts as a bridge or gateway to an appropriate network which may be wired or wireless. The present invention relates to WLANs operating in the infrastructure mode.

To find an access point, a client listens for beacon messages which are transmitted by the access point. After finding an access point, the client is authenticated by the WLAN so that the WLAN knows who the client is. After authentication, the WLAN then determines what the client is authorized to do on the WLAN. The authentication and authorization of clients is a form of security which attempts to prevent unauthorized users from accessing the WLAN.

In a WLAN defined in IEEE specification 802.11 (802.11 WLAN), standard security measures have been found to be ineffective in many applications. For example, during authentication the WLAN checks an identification provided by the client. The identification is typically performed using media access control identification (MAC-ID). However, an attacker sniffing wireless transmissions will be able to discover and use a valid MAC-ID. Wired equivalency privacy (WEP) encryption, which is used in 802.11 WLANs, has been found to be adequate for preventing only casual intruders who will not spend the time or effort to break the WEP key. However, determined attackers are able the break the WEP key and gain access.

Virtual Private Networks (VPNs) use a public network, such as the internet, or a wired or wireless WLAN, to connect remote sites or clients together. For example, a VPN includes “virtual” connections routed through the public network which are used to connect a company's private network to a remote site or an employee. If a user wants to use a WLAN to contact the VPN, some security is required for communication from the user through the WLAN to the VPN.

### SUMMARY OF THE INVENTION

An object of the present invention is to provide a security procedure for accessing a server in a virtual private network via a Wireless Local Area Network which overcomes the problems of the prior art.

The present invention uses a more robust security measure which uses Internet Protocol Security (IPSec) for wireless encryption. IPSec is an IP or network layer-based security protocol which provides better encryption algorithms and more comprehensive authentication than the WLAN standard.

The object of the present invention is met by a security procedure for communications between an authentication server in a wireless local area network and a client device, the wireless local area network having access points connected to the authentication server. The procedure includes the steps of identifying, by a client device, an access point of the wireless local area network, and performing an authentication process for authenticating the client device by exchanging management frames between the client device and the authentication server through the access point, wherein IPSec security is invoked for communications between the client device and the authentication server during the authentication process.

The object of the present invention is also met by a security procedure for invoking IPSec security for communication of an authentication packet from a client to an authentication server in a wireless local area network, the procedure including the steps of generating a message to be sent at the transport layer, building Internet Protocol and Transport Control Protocol headers for the message, selecting a security policy in accordance with a security policy database after the step of building Internet Protocol and Transport Control Protocol headers, and processing the packet according to the selected security policy. According to this inventive procedure, the steps involving the transport layer are performed before the steps involving the network layer.

The object of the present invention is further met by a wireless network comprising a plurality of interconnected components, the wireless network allowing access by wireless clients. The plurality of interconnected components include at least one access point through which client devices are connectable to the wireless network, and an authentication server connected to the at least one access point, the authentication server and the at least one access point being operatively arranged for performing an authentication process for authenticating client devices desiring access to the wireless network. Furthermore, the authentication server and the access points are operatively arranged for communicating using IPSec encrypted communications with the client during the authentication process.

The authentication server and the client include a computer readable memory storing computer-executable instructions for invoking IPsec security for each packet to be sent between the client device and the authentication server, the memory including instructions for generating a message to be sent at the transport layer, building Internet Protocol and Transport Control Protocol headers for the message, selecting a security policy in accordance with a security policy database after the step of building Internet Protocol and Transport Control Protocol headers, and processing the packet according to the selected security policy.

After authentication by the wireless local area network, the client exchanges data with a server in a virtual private network. The virtual private network may be wired or wireless. The packets sent between the client device and the server may also be encrypted and/or encapsulated using IPSec security features. According to the present invention, the tunnel mode of IPSec security features is used for communications between the client device and the server.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic diagram of a Wireless Local Area Network according to the present invention;

FIG. 2 is a flow diagram depicting the steps for connecting a client to a wireless local area network according to the present invention;

FIG. 3 is a flow diagram depicting a security procedure invoking IPsec according to the prior art;

FIG. 4 is a flow diagram depicting the security procedure invoking IPsec according to the present invention;

FIG. 5 is a block diagram showing the protocol architecture related to the creation of the socket buffer;

FIG. 6 is a diagram showing the prior art structure of an IP datagram;

FIG. 7 is a block diagram showing the IPSec function in each of the client device and the end device in communication with the client device;

FIG. 8 is a block diagram showing the functions of the Security Policy Engine of a program for implementing IPSec according to the present invention; and

FIG. 9 is a block diagram showing the functions of the Key Exchange Engine of a program for implementing IPSec according to the present invention.

### DETAILED DESCRIPTION OF THE PRESENTLY PREFERRED EMBODIMENTS

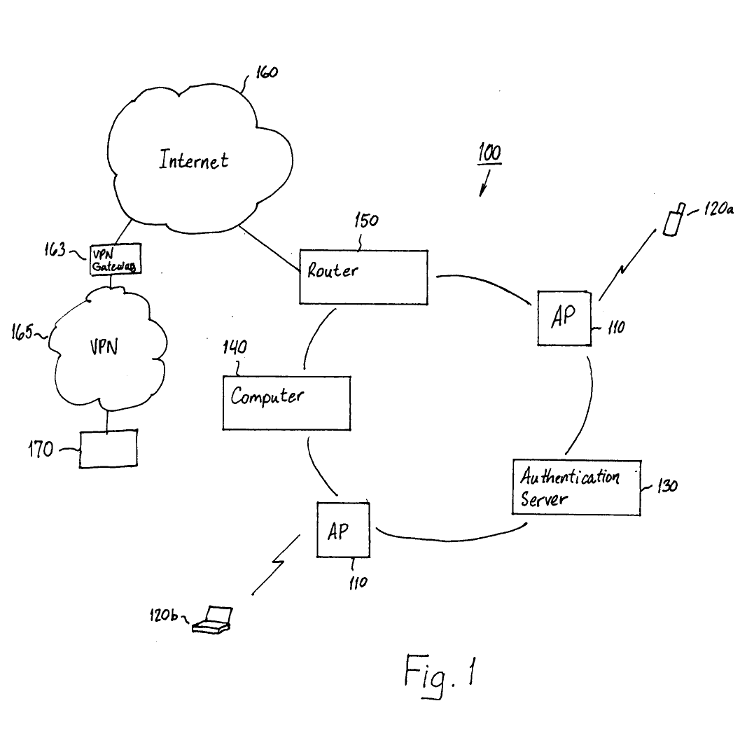

FIG. 1 is a schematic diagram showing an 802.11 Wireless Local Area Network (WLAN) system according to the present invention including a WLAN 100 having access points 110. Clients 120a, 120b send communications to the WLAN 100 through one of the access points 11. The communication may, for example, include a request to access a server 170 or website in a wired or wireless virtual private network (VPN) 165. The clients may use any wireless communication device having wireless capabilities such as a mobile terminal (client 120a), i.e., mobile phone or personal digital assistant (PDA), or a laptop computer (client 120b). The access points 110 act as a bridge between clients 120a, 120b and the WLAN 100. A computer 140 and a router 150 connected to a network 160 such as the internet for providing internet access for the clients 120a, 120b may also be connected as part of the WLAN 100. However, each client must be authenticated and authorized before communications with the WLAN 100 can be established. According to the present invention, an authentication server 130 is connected to each access point 110 for authenticating and authorizing each of the clients 120a, 120b.

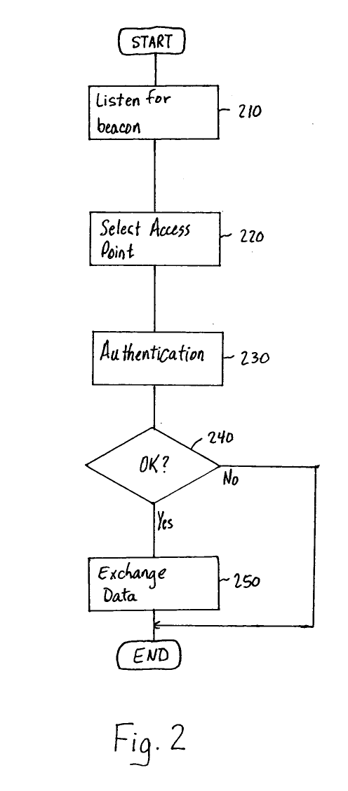

FIG. 2 is a flow diagram showing the step for connecting a client to the WLAN using access points. All access points periodically transmit beacon messages indicating their location and services. At step 210, a client listens for beacon messages to identify access points within range. The client then selects an access point and initiates communication at step 220. Authentication is performed by exchanging management frames at step 230. More specifically, the management frames are exchanged between the client device 120a, 120b and the authentication server 130. If the client is determined to be authenticated at step 240, data may be exchanged between the client and the network connected to the access point in step 250. To improve security, IPsec security measures are used for communications between the clients 120a, 120b and the WLAN 100. IPsec is defined in Request for Comments: 2401 (RFC 2401), issued by the Internet Engineering Task Force, November 1998, the entire contents of which are incorporated herein by reference. IPsec provides security services at the IP layer by enabling a system to selected required security protocols, determine the algorithm(s) to use for the service(s), and put in place any cryptographic keys required to provide the requested services.

As indicated above, management frames are exchanged between the client 120a, 120b and the authentication server 130 (see FIG. 1) during the authentication in step 230. IPSec encryption and encapsulation is used for the management frames exchanging authentication data between the client 120a, 120b and the authentication server 130 in the WLAN 100 during step 230. After authentication by authentication server 130, IPSec encryption may also be implemented for communications of data in step 250 between the client 120a, 120b and the server 170 as discussed in more detail below.

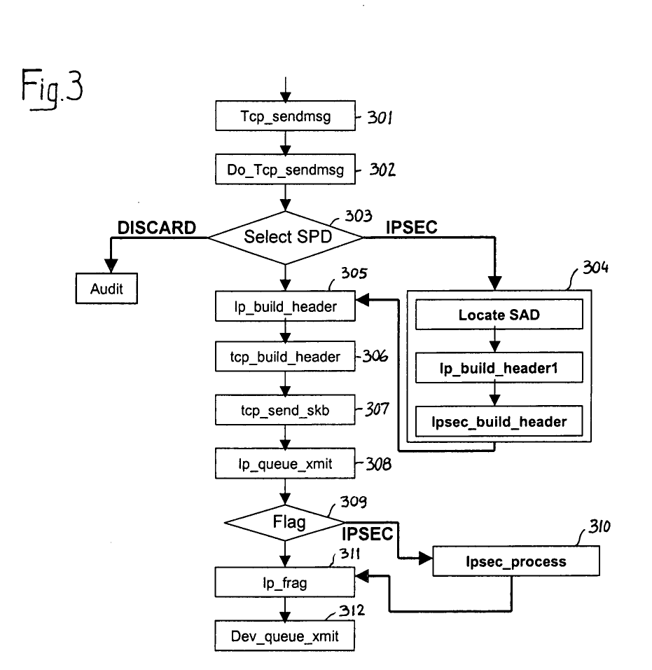

FIG. 3 shows a procedure for sending packets between two devices using Internet Protocol Security (IPsec) according to RFC 2401, wherein each outbound packet generated in steps 301 and 302 is compared against the Security Policy Database (SPD) to determine what security policy applied and what processing is required for the packet in step 303. The packet may be afforded IPsec security services, discarded, or allowed to bypass Ipsec. The SPD is a list of policy entries, wherein each of the policy entries is keyed by one or more selectors that define the set of IP traffic encompassed by the policy entry.

If it is determined at step 303 that IPsec security is to be applied, the packet is mapped to a security association (SA), or a security associated bundle, in step 304. As defined in RFC 2401, the SA is a security pact agreed upon by two systems involved in the message. The SA is identified by a security parameter index (SPI), IP destination address, and a security protocol (Authentication Header (AH) or Encapsulating Security Payload (ESP)). If no SA exists for communication between the two device, the two devices must enter negotiations to determine the SA before data can be communicated. If an appropriate SA is identified in step 304, IP and TCP packet headers are added to the packet in steps 305 and 306. A socket buffer is sent, in TCP layer, in step 307. Finally, the packet is queued in step 308.

If IPsec security is determined at step 303 to be bypassed, steps 305-308 are performed on the packet without performing step 304.

After step 308 it is again determined whether IPsec is to be applied to the packet, step 309. If IPsec is to be applied, step 10 is performed to implement the IPsec encryption. In step 311, the packets are separated into IP protocol fragments and transmitted in step 312.

The procedure of FIG. 3 involves both the transport layer and the internet (network) layer both before and after the steps of selecting the security policy and determining the security association, which is an inefficient use of resources.

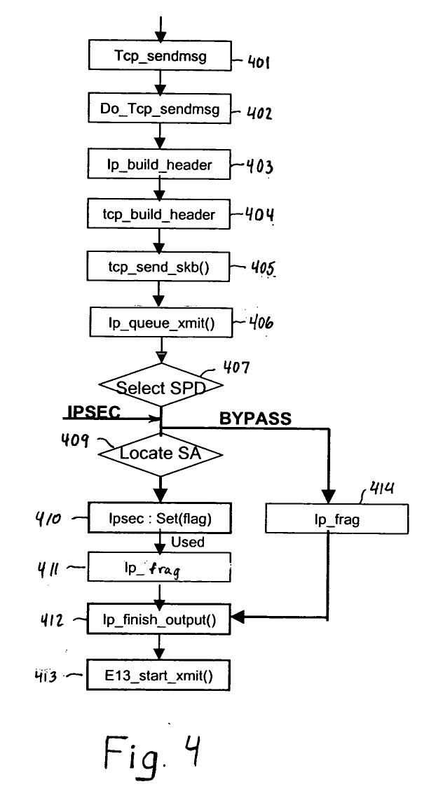

FIG. 4 shows a procedure for processing packets using IPsec according to the present invention. According to the inventive IPsec procedure shown in FIG. 4, all the steps requiring the TCP or transport layer are performed first. The outbound packet is generated in steps 401 and 402. Instead of determining the security policy, the IP and TCP headers to be added to the packets are built in steps 403 and 404. A send socket buffer is generated at step 405 and the socket buffer is queued at step 406. After step 405, the procedure of FIG. 4 enters the network layer and does not re-enter the transport layer. At step 407, the outbound packet is compared with the SPD to determine what security policy applied and what processing is required for the packet in step 407. The packet may be afforded IPsec security services, discarded, or allowed to bypass IPsec.

If it is determined at step 407 that IPsec security is to be applied, the packet is mapped to a security association (SA), or a security associated bundle, in step 409. IPSec encryption is applied in step 410 and the packets are separated into IP protocol fragments in step 411. In the preferred embodiment, IPSec tunnel mode is used. The protocol fragments to be output are assembled at step 412. The packet is then sent to the device transmit queue in step 413. If it is determined that IPSec is to be bypassed, the packet is separated into IP protocol fragments in step 414 and sent to the output 412 and the device transmit queue in step 413.

The procedures described with reference to FIGS. 3 and 4 may be incorporated as a computer program saved in a memory as a part of or connected to the authentication server 130 and clients 120a, 120b. Furthermore, these programs may run on any operating system such as, for example, Windows or Linux. During authentication, when a client 120a, 120b is to transmit authentication data to the authentication server 130, the client 120a, 120b, at step 408 determines the security policy that applies to such a communication. In step 409, the client 120a, 120b determines a security association that applies to communications with the authentication server 130. IPSec encryption is applied to the data according to the security association, step 410-412, and the data is transmitted to the authentication server 130, step 413. Once the data arrives at the authentication server, the authentication server 130 determines the identity of the sender and determines the security association that applies and decrypts the data. In this way, the data is encrypted as it is sent from the client 120a, 120b to the authentication server 130.

After the client 120a, 120b is authenticated to the WLAN, the client 120a, 120b may communicate with the server 170 over the WLAN. The client may also use IPSec security procedures for communications between the client 120a, 120b and the server 170. In known implementations of VPN/IPSec, the IPSec is implemented in tunnel mode between gateways, i.e., the WLAN gateway and a VPN gateway. In contrast, the present invention uses tunnel mode IPSec between the client device 120a, 120b and the server 170 in the virtual private network 165. The process described above with respect to FIGS. 3 and 4 also applies to this communication. However, the implementation of IPSec between the client device 120a, 120b and the server 170 uses different security policies and security associations than the implementation of IPSec between the client devices 120a, 120b and the authentication server 130.

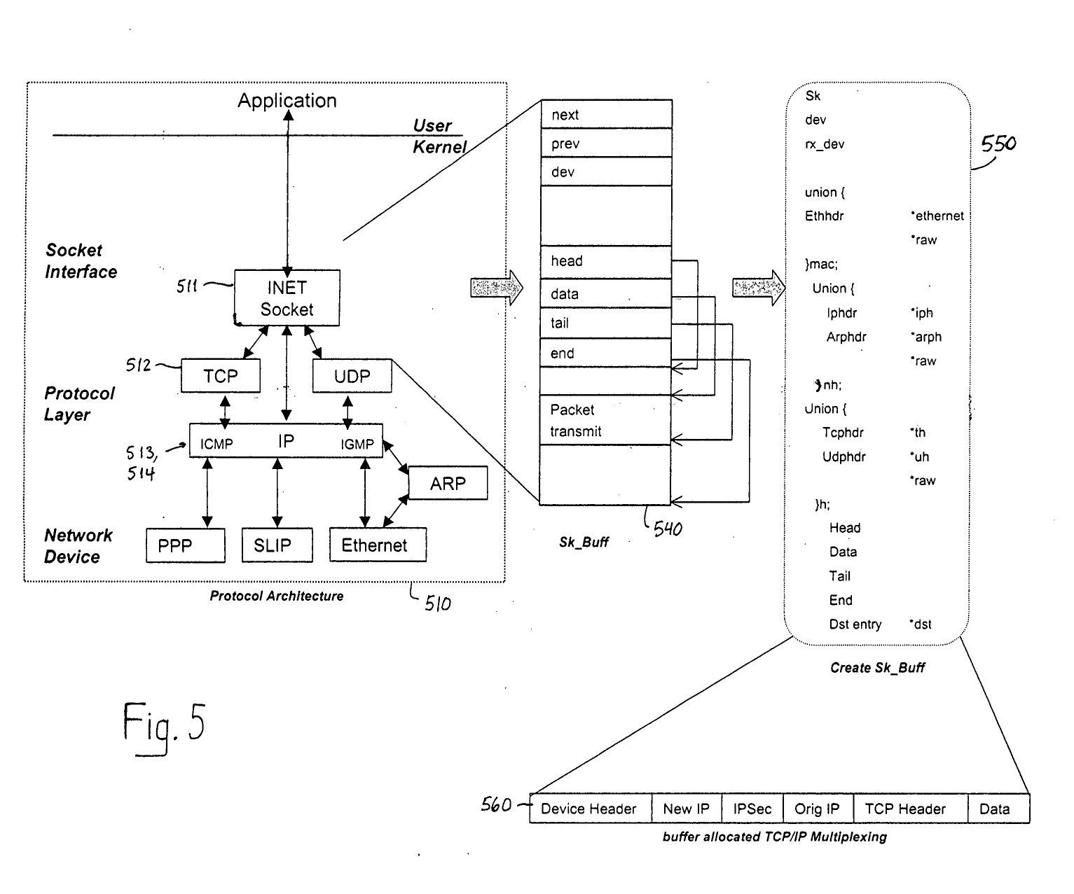

FIG. 5 shows a protocol architecture 510 used for implementing IPSec in a device, i.e.,user device 120a, 120b, authentication server 130, or network server 170. A socket interface, such as a INET socket 511 generates a packet structure 540 of a buffer (an example of an actual packet 550 is shown). A TCP header is added to the packet structure by TCP protocol layer 512. An IP header is added in front of the TCP header by the IP protocol layer 513. An IPSec header is added in front of the IP protocol header in accordance with IPSec. In accordance with the tunnel mode of IPSec, a new IP header is added in front of the IPSec header and a device header is added by the network device 514.

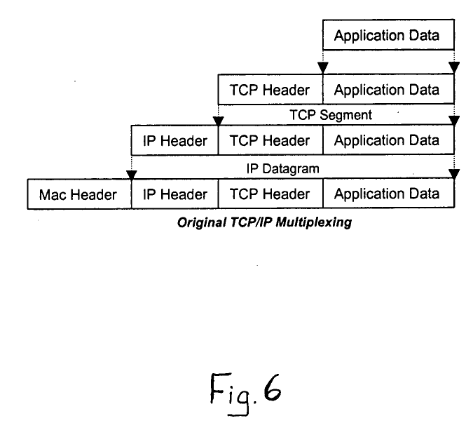

As a comparision, FIG. 6 shows a packet structure with conventional TCP/IP multiplexing using a MAC header in accordance with the WLAN standards which does not implement the IPSec protocol.

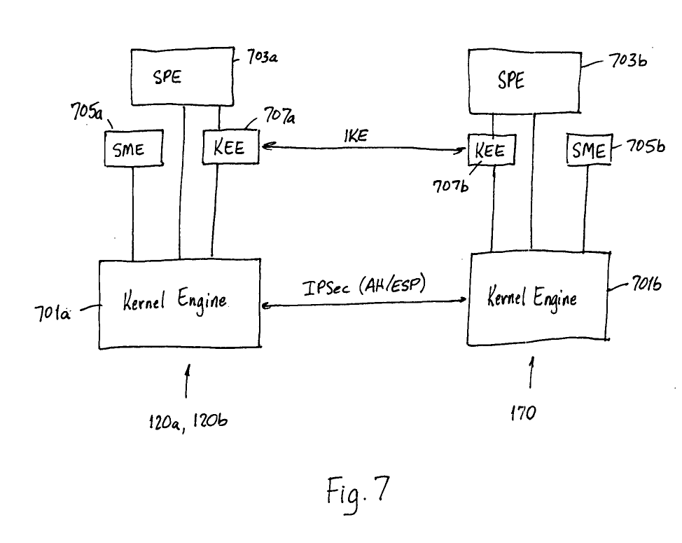

As noted above, the user device 120a, 120b may attempt to access a network element, i.e., server 170, in a virtual network. FIG. 7 is a schematic diagram showing the main program structures used to implement the security procedure of the present invention shown in FIGS. 3 and 4. The network element 170 in the virtual network connected to the WLAN is on the right side of FIG. 7 and the client device is on the left side of FIG. 7. Each has the same structure including a Kernel Engine 701a, 701b, a security policy engine 703a, 703b, a security management engine 705a, 705b, and a key exchange engine 707a, 707b. The kernel engine 701a, 701b performs the encryption and decryption of packets sent and received based on the applicable SA for the particular communication.

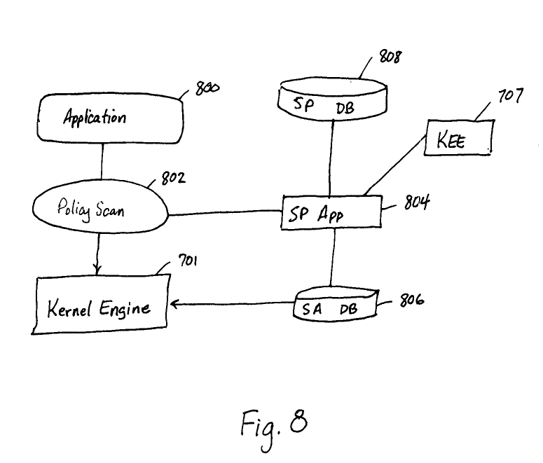

FIG. 8 discloses the security policy engine structure and function for a communication device. The function will be described for a request by a client device 120a, 120b to access a server 170. When a request for access to a server is made at 800, the client device must first be authenticated by the WLAN. A policy scan 802 is performed to determine whether IPSec policy applies using the Security policy application 804 and Security association database 806. The kernel engine 701 receives the result and applies the IPSec encryption and encapsulation of the determined security association to the data packet to be sent to the authentication server 130. The authentication server decrypts the data packet and authenticates the client device 120a, 120b. Once the client is authenticated by the authentication server 130 in the WLAN, the client can send data to the server 170 in the VPN 165. This communication may also use IPSec encryption and/or encapsulation using a second SA. Both the above described implementations of IPSec use the tunnel mode of IPSec.

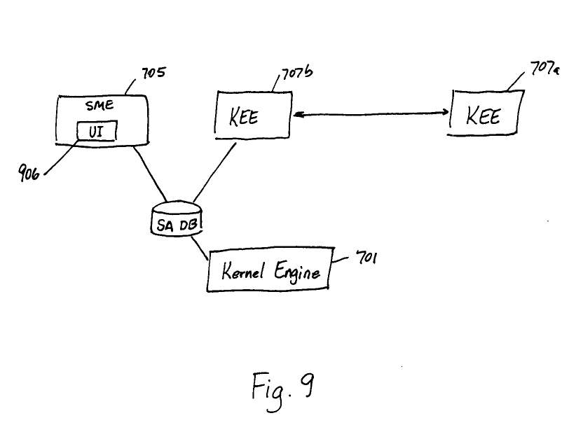

For the above described communications, if no policy exists, the two communication devices, i.e., the client 120a, 120b and the server 130 must enter negotiations to determine a security policy and security association before IPSec communications are possible. During the negotiation, the key exchange engines 707a, 707b of each communication device negotiate to determine a key. The result of the negotiation is sent to the security association database of each communication device. The kernel 701 retrieves the key from the security association database 906. As shown in FIG. 9, the SA database 806 may also be manually controlled using a user interface through the security management engine 705.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A security procedure for communications between a wireless local area network and a client device, the wireless local area network having access points connected to an authentication server, said procedure comprising the steps of:
identifying, by a client device, an access point of the wireless local area network; and
performing an authentication process for authenticating the client device by exchanging management frames between the client device and the authentication server through the access point, wherein IPsec security is invoked for communications between the client device and the authentication server during the authentication process.

2. The security procedure of claim 1, wherein IPsec security for each packet is invoked according to the following procedure:
generating a message to be sent at the transport layer;
building Internet Protocol and Transport Control Protocol headers for the message;
selecting an IPsec security policy in accordance with a security policy database after the step of building Internet Protocol and Transport Control Protocol headers; and
processing the packet according to the selected security policy.

3. The security procedure of claim 2, further comprising the step of generating a send socket buffer after said step of building Internet Protocol and Transport Control Protocol headers and before said step of selecting an IPsec security policy.

4. The security procedure of claim 2, further comprising the step of locating a security association for the packet if IPsec security is to be applied to the packet in accordance with the selected security policy.

5. The security procedure of claim 4, further comprising the step of performing IPsec encryption in a tunnel mode in accordance with the located security association.

6. The security procedure of claim 2, wherein all steps in the transport layer required for processing a packet to be sent between the access point and the authentication server are performed before the step of selecting an IPsec security policy.

7. The security procedure of claim 6, wherein said step of selecting an IPsec security policy and all steps required for processing the packet to be sent between the access point and the authentication server performed after the step of selecting an IPsec security policy are performed in the network layer.

8. The security procedure of claim 1, wherein said step of performing an authentication process for authenticating the client device invokes IPSec security using a first security association and said security procedure further comprises the step of implementing an IPSec security for communication through the wireless local area network between the client device and the network element in a virtual private network using a second security association.

9. The security procedure of claim 8, wherein the IPSec security for communication between the client device and the network element is implemented in a tunnel mode.

10. The security procedure of claim 8, wherein the virtual private network is a wireless virtual private network.

11. A security procedure for invoking IPsec security for communication of a packet in a network, comprising the steps of:
generating a message to be sent at the transport layer;
building Internet Protocol and Transport Control Protocol headers for the message;
selecting an IPsec security policy in accordance with a security policy database after the step of building Internet Protocol and Transport Control Protocol headers; and
processing the packet according to the selected IPsec security policy.

12. The security procedure of claim 11, further comprising the step of generating a send socket buffer after said step of building Internet Protocol and Transport Control Protocol headers and before said step of selecting an IPsec security policy.

13. The security procedure of claim 11, further comprising the step of locating a security association for the packet if IPsec security is to be applied to the packet in accordance with the selected IPsec security policy.

14. The security procedure of claim 13, further comprising the step of performing IPsec encryption in a tunnel mode in accordance with the located security association.

15. The security procedure of claim 11, wherein all steps in the transport layer required for processing a packet to be sent between the access point and the authentication server are performed before the step of selecting an IPsec security policy.

16. The security procedure of claim 15, wherein said step of selecting an IPsec security policy and all steps required for processing the packet to be sent between the access point and the authentication server performed after the step of selecting an IPsec security policy are performed in the network layer.

17. A wireless network comprising a plurality of interconnected components, said wireless network allowing access by wireless clients, said plurality of interconnected components comprising:
at least one access point through which client devices are connectable to the wireless network; and
an authentication server connected to said at least one access point, said authentication server and said at least one access point being operatively arranged for performing an authentication process for authenticating client devices desiring access to said wireless network, and said authentication server and said access points being operatively arranged for communicating using IPsec encrypted communications during the authentication process.

18. The wireless network of claim 17, wherein said plurality of interconnected components further comprises a router connected to a wide area network.

19. The wireless network of claim 17, wherein each of said at least one access point and said authentication server comprise a computer readable memory storing computer-executable instructions for invoking IPsec security for each packet to be sent between said access point and said authentication server, said memory comprising instructions for:
generating a message to be sent at the transport layer;
building Internet Protocol and Transport Control Protocol headers for the message;
selecting an IPsec security policy in accordance with a security policy database after the step of building Internet Protocol and Transport Control Protocol headers; and processing the packet according to the selected IPsec security policy.

20. The wireless network of claim 19, said memory further comprising instructions for generating a send socket buffer after said step of building Internet Protocol and Transport Control Protocol headers and before said step of selecting an IPsec security policy.

21. The wireless network of claim 19, said memory further comprising instructions for locating a security association for the packet if IPsec security is to be applied to the packet in accordance with the selected IPsec security policy.

22. The wireless network of claim 21, said memory further comprising instructions for performing IPsec encryption in a tunnel mode in accordance with the located security association.

23. The security procedure of claim 19, wherein all instructions which are performed in the transport layer required for processing a packet to be sent between the access point and the authentication server are performed before selecting an IPsec security policy.

24. The security procedure of claim 23, wherein said instructions for selecting an IPsec security policy and all instructions required for processing the packet to be sent between the access point and the authentication server performed after the selection of an IPsec security policy are performed in the network layer.
